(19) United States
(12) Patent Application Publication
(10) Pub. No.: US 2011/0195105 A1
(43) Pub. Date: Aug. 11, 2011

(54) Foam Cellular Matrix Impregnated With Anti-Microbial Active Agent For Use In Negative Pressure Wound Therapy Applications And Process For Producing The Same

(76) Inventors: John I. Nanos, Ann Arbor, MI (US); Fuminori Horio, Ann Arbor, MI (US)

(21) Appl. No.: 12/898,890

(22) Filed: Oct. 6, 2010

Related U.S. Application Data
(60) Provisional application No. 61/302,473, filed on Feb. 8, 2010.

(51) Int. Cl. A01N 25/08; A01N 59/16; A01P 1/00

(52) U.S. Cl. 424/409; 424/618

(57) ABSTRACT

A foam cellular matrix and process for making the matrix. The matrix is for use in negative pressure wound therapy (NPWT) applications. The matrix contains inorganic anti-microbial agent, which is added during foam generation. The elements mixed during foam generation comprise a polyol, a surfactant, a catalyst, water, an isocyanate, and the inorganic anti-microbial agent in the ratio of 0 to 6 parts inorganic anti-microbial agent to 100 parts polyol.

### CROSS-REFERENCE TO RELATED APPLICATIONS

This application claims the benefit of U.S. Provisional Application 61/302,473 filed Feb. 8, 2010, which is herein incorporated by reference in its entirety.

### FIELD OF THE INVENTION

The present disclosure is in the technical field of foam cellular matrices with impregnated anti-microbial active agent. More particularly, the present disclosure is in the technical field of foam cellular matrices impregnated with anti-microbial active agent, which is added during foam generation, and is for use in negative pressure wound therapy (NPWT) applications.

### BACKGROUND OF THE INVENTION

Wound closure involves the inward migration of epithelial and subcutaneous tissue adjacent the wound. This migration is ordinarily assisted through the inflammatory process, whereby blood flow is increased and various functional cell types are activated. Through the inflammatory process, blood flow through damaged or broken vessels is stopped by capillary level occlusion, after which cleanup and rebuilding operations may begin. Unfortunately, this process is hampered when a wound is large or has become infected. In such wounds, a zone of stasis (i.e. an area in which localized swelling of tissue restricts the flow of blood to the tissues) forms near the surface of the wound.

Without sufficient blood flow, the epithelial and subcutaneous tissues surrounding the wound not only receive diminished oxygen and nutrients, but are also less able to successfully fight bacterial infection. Hence, it is more difficult to naturally close the wound.

One treatment that has been developed for wounds that are large and or infected is negative pressure wound therapy (NPWT). NPWT is also known as vacuum assisted closure (VAC). NPWT works to minimize the zone of stasis which is discussed above. NPWT typically involves a mechanical-like contraction of the wound with a simultaneous removal of excess fluid. Hence, NPWT augments the body's natural inflammatory process while minimizing the intrinsic side effects, such as the production of edema caused by the increased blood flow absent the necessary vascular structure for proper venous return. The build-up of edema is also known as maceration.

### BRIEF SUMMARY OF THE INVENTION

The present disclosure describes a foam cellular matrix impregnated with anti-microbial active agent which is added during foam generation and is for use in NPWT, and process of producing the same. The elements of the foam cellular matrix comprise: a polyol; a surfactant; a catalyst; water; an isocyanate; and an inorganic anti-microbial agent.

The polyol is a polymer with a hydroxyl functional group. Examples of polyol are polyester polyol, polyether polyol, or the like.

The catalyst is amine catalyst, metal catalyst, or the like.

The surfactant is silicone surfactant or the like.

The isocyanate is toluene diisocyanate or the like.

In one embodiment, the inorganic anti-microbial agent is silver ion (Ag⁺) in a zeolite matrix, wherein the zeolite matrix is used in an amount between 0 and 5 parts of zeolite matrix per 100 parts of polyol by weight. The zeolite matrix contains approximately 0.6% silver ion (Ag⁺) content by weight. Note that if the silver ion (Ag⁺) content in the zeolite matrix is varied, the proportion of zeolite matrix used in the foam cellular matrix also should be varied to maintain a proper silver ion (Ag⁺) concentration. Hence, different levels of silver ion (Ag⁺) content by weight within the zeolite matrix are possible.

In a separate embodiment, the inorganic anti-microbial agent is elemental silver (Ag⁰) nanocrystals. The elemental silver (Ag⁰) nanocrystals are at least 99% elemental silver (Ag⁰) and form a powder.

An embodiment of a NPWT device comprises: a negative pressure source; a pad for placement within a wound, wherein the pad comprises a foam cellular matrix; a drape for sealing the pad on the wound, enclosing the pad on the wound, and for maintaining a negative pressure on the wound; and a fluid communication means for communicating between the negative pressure source and the pad.

The negative pressure source can be a vacuum, pump, or the like.

The pad comprises a foam cellular matrix with impregnated anti-microbial active agent which is added during foam generation, which is described earlier in this disclosure. The drape forms an impermeable barrier, with the exception of the fluid communication means which is allowed to suction fluid. The drape can be a flexible sheet made of plastic, latex, rubber, or the like.

The fluid communication means can be tubing which is operationally connected to both the pad and the negative pressure source. Note that the fluid communication means passes through the drape.

The scope of the invention is defined by the claims, which are incorporated into this section by reference. A more complete understanding of embodiments on the present disclosure will be afforded to those skilled in the art, as well as the realization of additional advantages thereof, by consideration of the following detailed description of one or more embodiments. Reference will be made to the appended sheets of drawings that will first be described briefly.

The following detailed description of the invention is merely exemplary in nature and is not intended to limit the invention or the application and uses of the invention. Furthermore, there is no intention to be bound by any theory presented in the preceding background of the invention or the following detailed description of the invention.

### BRIEF DESCRIPTION OF THE DRAWINGS

FIG. 1 shows an exploded view of an NPWT dressing.

FIG. 2 shows a cross-section view of a foam cellular matrix with impregnated anti-microbial active agent which is added during foam generation.

FIG. 3 shows a cross-section view of a foam strut in foam cellular matrix with impregnated anti-microbial active agent which is added during foam generation.

FIG. 4 shows a cross-section view of zeolite containing silver ion (Ag⁺) in a foam strut within a foam cellular matrix with impregnated anti-microbial active agent which is added during foam generation.

FIG. 5 shows a cross-section view of elemental silver (Ag⁰) nanocrystals in a foam strut within a foam cellular matrix with impregnated anti-microbial active agent which is added during foam generation.

### DETAILED DESCRIPTION OF THE INVENTION

While NPWT has been successful, there are aspects that can be improved. One such aspect is the use of an anti-microbial agent in the wound. Using an anti-microbial agent limits detrimental bacterial growth within the wound. One anti-microbial agent that has been used is elemental silver.

Elemental silver is typically applied on the surface of the foam being used in the NPWT device. This causes two potential problems. First, there may be too high an initial silver concentration when the silver first comes into contact with the wound. This may be followed by a period of low silver concentration, since the elemental silver has already been used. Second, elemental silver can flake-off and silver particles then become embedded in the wound. This can cause acute toxicity to a patient.

A wide variety of novel and/or established anti-microbial compounds can be incorporated onto cellular matrices to control microbial contamination and to resist infection of the wound surface. U.S. Pat. App. 2006/0029675 A1 Ginther teaches the method of coating the antimicrobial active agent onto the complete surface area of the cellular material to enhance activity. The described and existing coating techniques are effective in their anti-microbial activity, yet the process of coating leads to added costs for manufacture as the active agents are applied in a secondary process after the foam has been produced and converted into roll goods or sheets. If a continuous foam roll cannot be produced, the coating process must utilize smaller dimensioned sheets which leads to a slower, discontinuous ancillary process.

The present disclosure describes a foam cellular matrix impregnated with inorganic anti-microbial active agent which is added during foam generation and is for use in NPWT, and a process of producing the same. In one embodiment the inorganic anti-microbial active agent used is a zeolite matrix containing ionic silver. The zeolite matrix is impregnated into the foam during foam generation so that it cannot flake-off and cause acute toxicity. Furthermore, initial ionic silver concentration and steady state ionic silver concentration in the wound can be modulated through a combination of zeolite concentration in the foam, ionic silver concentration within the zeolite, and the extent to which the zeolite is physically embedded within the foam cellular matrix.

A separate embodiment, the inorganic anti-microbial agent is elemental silver (Ag⁰) nanocrystals. The elemental silver (Ag⁰) nanocrystals are at least 99% elemental silver (Ag⁰) and form a powder. The elemental silver (Ag⁰) nanocrystals are impregnated into the foam during foam generation, so that they cannot flake-off and cause acute toxicity. Furthermore, initial ionic silver concentration and steady state ionic silver concentration in the wound can be modulated by varying elemental silver (Ag⁰) nanocrystal concentration within the foam.

One unexpected result and benefit of the disclosed invention is that it is more economical to produce than foam with elemental silver applied on the surface. This is because no secondary foam coating process is required. The anti-microbial agent is impregnated during foam production.

A second unexpected result of the disclosed invention is that less active ingredient (silver) is required for the ionic silver (Ag⁺) than elemental silver (Ag⁰). It is hypothesized that the reason for the lower required concentration of ionic silver (Ag⁺) versus elemental silver (Ag⁰) is due to the chemistry involved. Elemental silver (Ag⁰) becomes oxidized in the wound, converting to ionic silver (Ag⁺). The ionic silver (Ag⁺) is believed to be the active anti-microbial agent. Since the oxidation of elemental silver (Ag⁰) to (Ag⁺) does not fully occur, some of the elemental silver never gets converted to active anti-microbial agent.

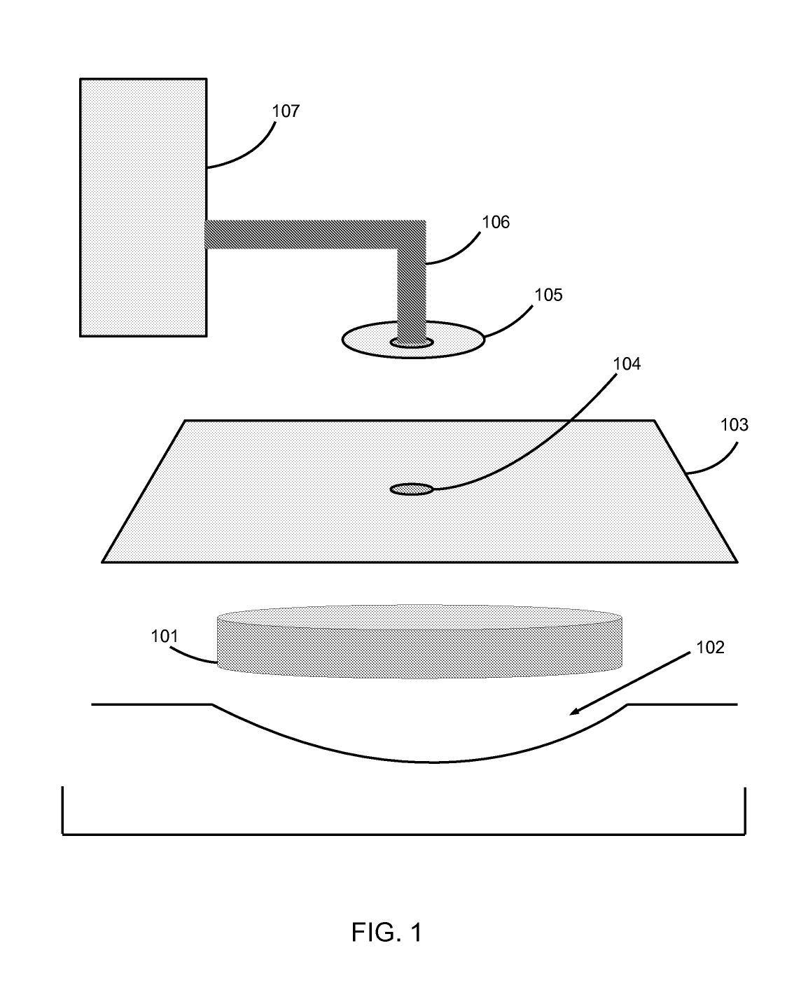

FIG. 1 shows an exploded view of an NPWT dressing. A pad 101 is placed within a wound area 102. A drape 103 is used to seal pad 101 on wound area 102, enclose pad 101 on wound area 102, and maintain a negative pressure on wound area 102. An opening 104 in drape 103 enables fluid to leave the enclosed area under drape 103. A fluid communication means 106 is attached to drape 103 using attachment 105 at the location of opening 104. A negative pressure source 107 is used to transfer fluid from wound area 102, to pad 101, then through opening 104, then through fluid communications means 106, into a storage volume within negative pressure source 107.

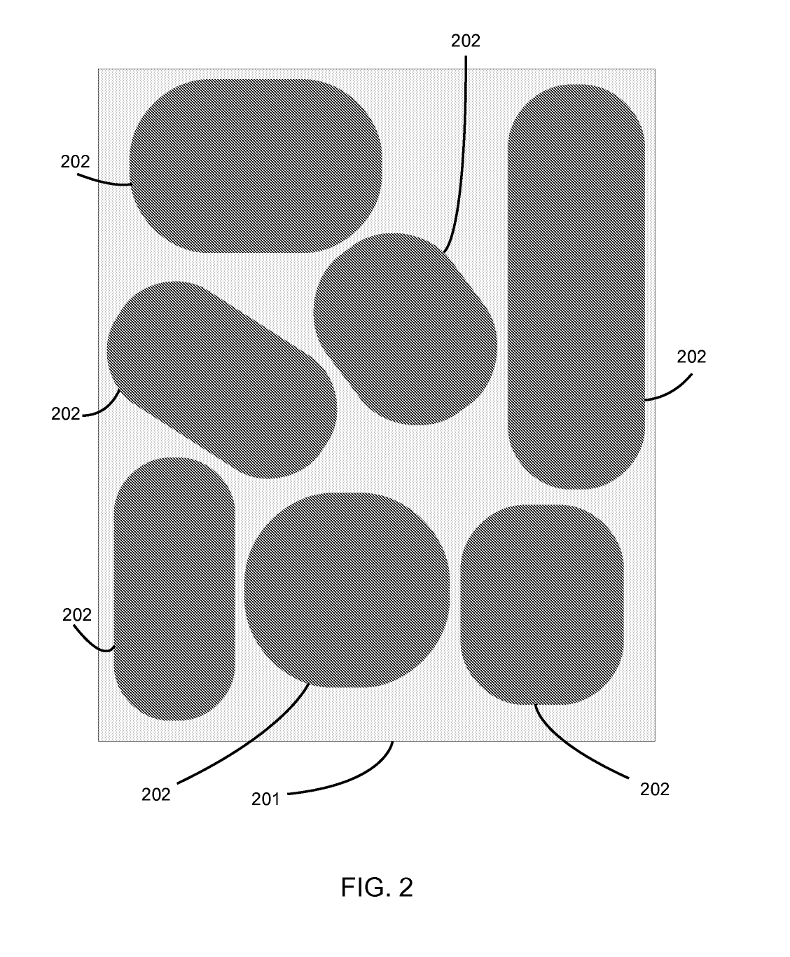

FIG. 2 shows a cross-section view of a foam cellular matrix with impregnated anti-microbial active agent which is added during foam generation. Voids 202 are interspersed throughout the foam cellular matrix 201.

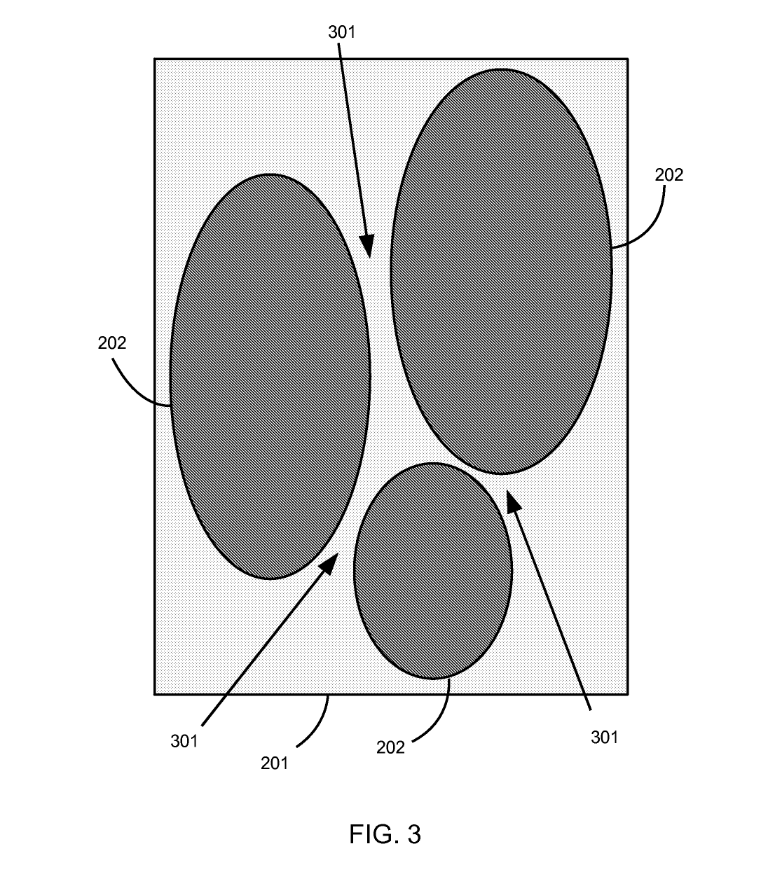

FIG. 3 shows a cross-section view of a foam strut in foam cellular matrix with impregnated anti-microbial active agent which is added during foam generation. Foam struts 301 are interspersed with voids 202 within the foam cellular matrix 201.

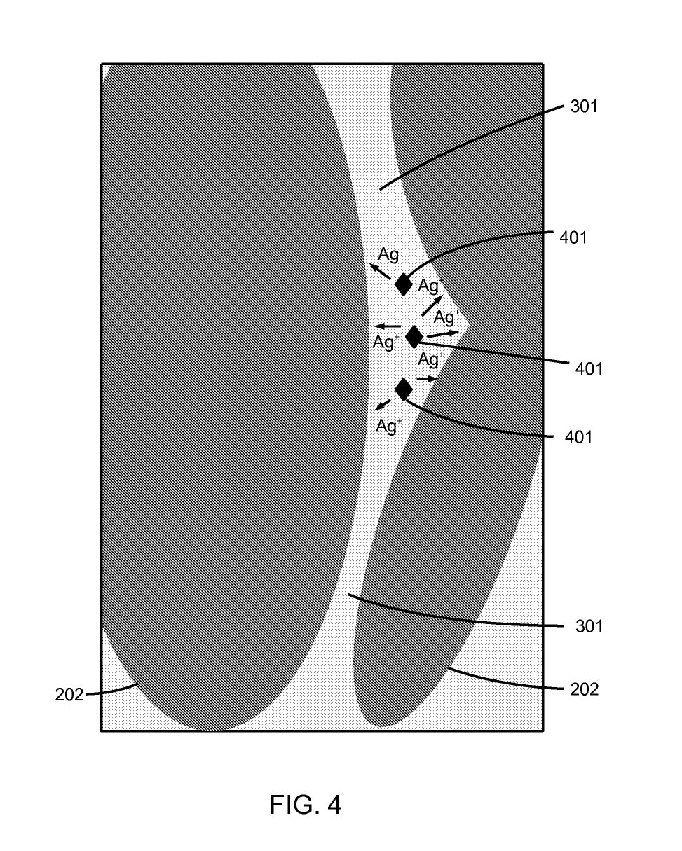

FIG. 4 shows a cross-section view of zeolite containing ionic silver (Ag⁺) in a foam strut within a foam cellular matrix with impregnated anti-microbial agent which is added during foam generation. Zeolite particles 401 are impregnated into the foam struts 301, which are interspersed with the voids 202. The direction of ionic silver (Ag⁺) flow is shown. Ionic silver (Ag⁺) flow is driven by an ionic silver (Ag⁺) gradient with higher concentrations at zeolite particles 401 and lower concentrations close to the voids 202.

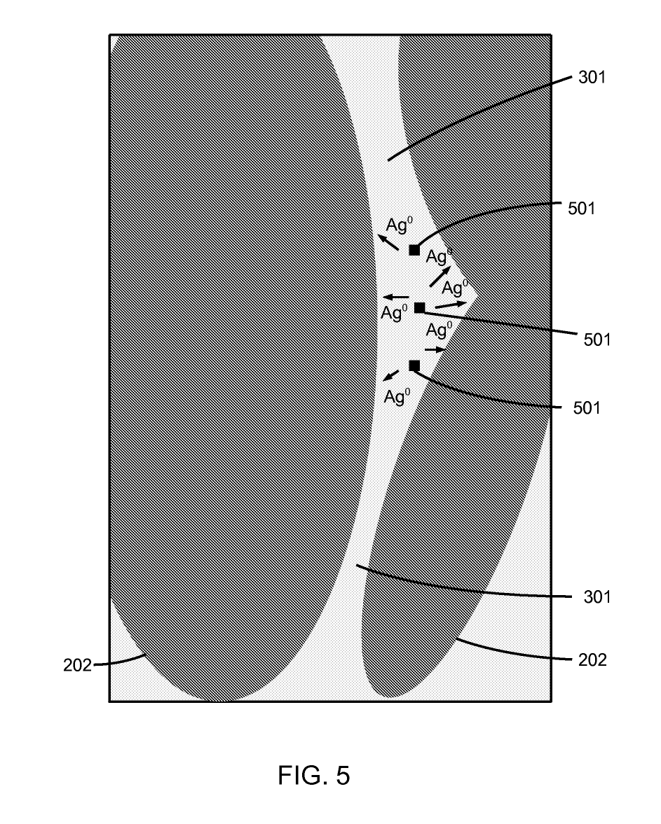

FIG. 5 shows a cross-section view of elemental silver (Ag⁰) nanocrystals in a foam strut within a foam cellular matrix with impregnated anti-microbial active agent which is added during foam generation. Elemental silver (Ag⁰) nanocrystals 501 are impregnated into the foam struts 301, which are interspersed with the voids 202. The direction of elemental silver (Ag⁰) flow is shown. Elemental silver flow is driven by a silver gradient with higher concentrations at the nanocrystals 501 and lower concentrations close to the voids 202. At some point, elemental silver (Ag⁰) oxidizes into its active form which is ionic silver (Ag⁺).

Table 1 shows laboratory results of a foam cellular matrix impregnated with zeolite containing ionic silver, which is added during foam generation. Varying concentrations of zeolite are shown with corresponding anti-microbial activity and foam status. At 0 parts zeolite per 100 parts polyol, there is no anti-bacterial action. At 5 parts zeolite per 100 parts polyol, there is adequate anti-bacterial action but the foam is damaged and ineffective. Hence, zeolite should be used in the range of 0-5 parts zeolite per 100 parts polyol by weight.

Table 2 shows laboratory results of a foam cellular matrix impregnated with elemental silver (Ag⁰) which is added during foam generation. Varying concentrations of elemental silver (Ag⁰) are shown with corresponding anti-microbial activity and foam status. At 0 parts elemental silver (Ag⁰) per 100 parts polyol, there is no anti-bacterial action. At 6 parts elemental silver (Ag⁰) per 100 parts polyol, there is adequate anti-bacterial action but the foam is damaged and ineffective. Hence, elemental silver (Ag⁰) should be used in the range of 0-6 parts elemental silver (Ag⁰) per 100 parts polyol by weight.

TABLE 1
Siver ion

| | | | | | | |
|---|---|---|---|---|---|---|
| Formulation (parts) | 1 | 2 | 3 | 4 | 5 | 6 |

| | | | | | | |
|---|---|---|---|---|---|---|
| N101 | 100 | 100 | 100 | 100 | 100 | 100 |
| B8330 | 1.5 | 1.5 | 1.5 | 1.5 | 1.5 | 1.5 |
| NE-500 | 0.6 | 0.6 | 0.6 | 0.6 | 0.6 | 0.6 |
| Water | 3.6 | 3.6 | 3.6 | 3.6 | 3.6 | 3.6 |
| T-80 | 45.01 | 45.01 | 45.01 | 45.01 | 45.01 | 45.01 |
| Zeomic AW-10N | 0 | 0.2 | 0.4 | 1 | 3 | 5 |
| Density (pcf) | 1.89 | 1.9 | 1.91 | 1.91 | 1.95 | 1.96 |
| Foam status | Good | Good | Good | Good | Good | Bad |
| | | | | | | Big scorch |

Anti-microbial test
1. Staphylococcus aureus

| | | | | | | |
|---|---|---|---|---|---|---|
| 0 hour (initial) | 900,000 | 900,000 | 900,000 | 900,000 | 900,000 | 900,000 |
| 24 hour | 950,000 | 500 | 200 | 50 | 0 | 0 |
| Antibacterial action | No | Yes | Yes | Yes | Yes | Yes |

2. Klebsiella pneumoniae

| | | | | | | |
|---|---|---|---|---|---|---|
| 0 hour (initial) | 1,600,000 | 1,600,000 | 1,600,000 | 1,600,000 | 1,600,000 | 1,600,000 |
| 24 hour | 1,500,000 | 1,000 | 600 | 100 | 0 | 0 |
| Antibacterial action | No | Yes | Yes | Yes | Yes | Yes |

N101: Polyester polyol, OHV = 50, By Nippon Polyurethane Industry Co., Ltd.
B8330: Silicone surfactant, By Evonik Co., Ltd.
NE-500: Amine catalyst, By Air products Co., Ltd.
T-80: Toluene diisocyanate, By BASF Co., Ltd.
Zeomic AW-10N: Anti-microbial agent. Siver ion in Zeolite matrix. Silver content 0.6% wt. By Sinanen Zeomic Co., Ltd.
Anti-microbial test method: Shake Flask Method, 2003 edition of the Society Industrial Technology for Anti-microbial Articles.

TABLE 2
Elemental silver

| Formulation (parts) | 1 | 2 | 3 | 4 | 5 | 6 |
|---|---|---|---|---|---|---|
| N101 | 100 | 100 | 100 | 100 | 100 | 100 |
| B8330 | 1.5 | 1.5 | 1.5 | 1.5 | 1.5 | 1.5 |
| NE-500 | 0.6 | 0.6 | 0.6 | 0.6 | 0.6 | 0.6 |
| Water | 3.6 | 3.6 | 3.6 | 3.6 | 3.6 | 3.6 |
| T-80 | 45.01 | 45.01 | 45.01 | 45.01 | 45.01 | 45.01 |
| Smart Silver AD-5 | 0 | 1 | 2 | 3 | 4 | 6 |
| Density (pcf) | 1.8 | 1.86 | 1.89 | 1.91 | 1.92 | 1.96 |
| Foam status | Good | Good | Good | Good | Good | Bad |
| | | | | | | Big scorch |

Anti-microbial test
1. Escherichia Coli

| | | | | | | |
|---|---|---|---|---|---|---|
| 0 hour (initial) | 140,000 | 140,000 | 140,000 | 140,000 | 140,000 | 140,000 |
| 24 hour | 950,000 | 30,000 | 10,000 | 1,000 | 50 | 0 |
| Antibacterial action | No | Yes | Yes | Yes | Yes | Yes |

Anti-microbial test method: AATCC TM 100-2004
N101: Polyester polyol, OHV = 50, By Nippon Polyurethane Industry Co., Ltd.
B8330: Silicone surfactant, By Evonik Co., Ltd.
NE-500: Amine catalyst, By Air products Co., Ltd.
T-80: Toluene diisocyanate, By BASF Co., Ltd.

For the purposes of this disclosure, ionic silver, silver ion, and (Ag⁺) are interchangeable terms.

For the purposes of this disclosure, elemental silver and (Ag⁰) are interchangeable terms.

While the present invention has been described with reference to exemplary embodiments, it will be readily apparent to those skilled in the art that the invention is not limited to the disclosed or illustrated embodiments but, on the contrary, is intended to cover numerous other modifications, substitutions, variations and broad equivalent arrangements that are included within the spirit and scope of the following claims.

We claim:

1. A foam cellular matrix containing an inorganic anti-microbial agent which is added during foam generation and is for use in NPWT, the foam cellular matrix comprising:
a polyol;
a surfactant;
a catalyst;
water;
an isocyanate; and
the inorganic anti-microbial agent in the ratio of 0 to 6 parts inorganic anti-microbial agent to 100 parts polyol.

2. The foam cellular matrix of claim 1, wherein the inorganic anti-microbial agent is ionic silver within a zeolite matrix.

3. The foam cellular matrix of claim 1, wherein the inorganic anti-microbial agent is elemental silver nanocrystals in a powder form.

4. The foam cellular matrix of claim 1, wherein the surfactant is a silicone surfactant.

5. The foam cellular matrix of claim 1, wherein the polyol is polyester polyol or polyether polyol.

6. The foam cellular matrix of claim 1, wherein the isocyanate is toluene diisocyanate.

7. The foam cellular matrix of claim 1, wherein the catalyst is an amine catalyst or a metal catalyst.

8. A process for producing a foam cellular matrix containing an inorganic anti-microbial agent which is added during foam generation and is for use in NPWT, the process comprising:
mixing a polyol, a surfactant, an amine catalyst, water, an isocyanate, and the inorganic anti-microbial agent in the ratio of 0 to 6 parts inorganic anti-microbial agent to 100 parts polyol; and
foaming the mixture to obtain the foam cellular matrix.

9. The process of claim 8, wherein the inorganic anti-microbial agent is ionic silver within a zeolite matrix.

10. The process of claim 8, wherein the inorganic anti-microbial agent is elemental silver nanocrystals in a powder form.

11. The process of claim 8, wherein the surfactant is a silicone surfactant.

12. The process of claim 8, wherein the polyol is polyester polyol or polyether polyol.

13. The process of claim 8, wherein the isocyanate is toluene diisocyanate.

14. The process of claim 8, wherein the catalyst is an amine catalyst or a metal catalyst.
